(19) United States
(12) Patent Application Publication
(10) Pub. No.: US 2010/0137021 A1
(43) Pub. Date: Jun. 3, 2010

(54) System, Method and Devices for Communications via a Mesh Network

(76) Inventors: Eric Sharret, New York, NY (US); Beth Flippo, Livingston, NJ (US); Igal Sharret, Livingston, NJ (US)

Correspondence Address: FAY KAPLUN & MARCIN, LLP, 150 BROADWAY, SUITE 702, NEW YORK, NY, 10038, US

(21) Appl. No.: 12/625,141

(22) Filed: Nov. 24, 2009

Related U.S. Application Data
(60) Provisional application No. 61/200,381, filed on Nov. 28, 2008.

(51) Int. Cl. H04M 1/00

(52) U.S. Cl. 455/550.1

(57) ABSTRACT

System, devices and methods for receiving an encoded voice communication from a mobile device, determining whether the encoded voice communication is destined for the device that received the encoded voice communication and, when the encoded voice communication is determined to be destined for another device, transmitting the encoded voice communication to a further device without sending an acknowledgement to the mobile device that sent the encoded voice communication.

### INCORPORATION BY REFERENCE

The following application hereby incorporates by reference the U.S. Provisional Application 61/200,381 filed on Nov. 28, 2008, and entitled “Field Programmable Devices and Systems Capable of Forming Ad Hoc Secure Wireless Mesh Networks for Exchanging Voice, Text Messages and Data” by inventor Igal Sharret in its entirety.

### BACKGROUND

Communicating with users within a network environment is essential for a variety of applications, including military applications, first responder applications, industrial applications, etc. This communication may include both data and voice communications to provide users with the information they need to accomplish the tasks to which they are assigned. One of the key features of modern communications systems is the ability to integrate mobile devices within the network so that users are not tethered to a fixed location. However, adding mobile devices to a network is more expensive and complicated than merely turning on a mobile device. A great deal of infrastructure such as cell towers, access points, switches, routers, etc., needs to be put in place for mobile devices to communicate between themselves and with other parts of the network. In addition, this infrastructure also needs to be maintained during normal operations and serviced when outages or other problems occur. Thus, the expense associated with this infrastructure is not only the initial cost of procuring and installing the infrastructure equipment, but also continuing costs of service and maintenance.

### SUMMARY OF THE INVENTION

A device having a receiver receiving an encoded voice communication from a first further device, wherein the receipt of the encoded voice communication is not acknowledged by the device to the first further device, a processing component determining if the encoded voice communication is destined for the device and a transmitter transmitting the encoded voice communication to a second further device, when it is determined that the encoded voice communication is not destined for the device.

A system having a plurality of mobile devices forming a network by each mobile device having a wireless connection to at least one of the other mobile devices, one of the mobile devices receiving an encoded voice communication from a first further one of the mobile devices, determining whether the encoded voice communication is destined for the one of the mobile devices and, when the encoded voice communication is determined to be destined for another one of the mobile devices, transmitting the encoded voice communication to a second further one of the mobile devices without sending an acknowledgement to the first one of the mobile devices.

A system having a plurality of mobile devices forming a first portion of a communications network by each mobile device having a first wireless connection with at least one other mobile device, communication via the first wireless connection being based on a first protocol, a zip module forming a second portion of the communications network by having a second wireless connection with at least one of the mobile devices, communication via the second wireless connection being based on the first protocol and a network gateway forming a third portion of the communications network by having a connection with the zip module, communication via the connection being based on a second protocol, and a connection to further networks, communication via the connection being based on a third protocol.

### BRIEF DESCRIPTION OF THE DRAWINGS

FIG. 1 shows an exemplary mesh network including a plurality of nodes.

FIG. 2a shows an exemplary low power handheld (LPH) device that may be at least one of the nodes in the exemplary mesh network illustrated in FIG. 1.

FIG. 2b shows an exemplary relay device that may also be at least one of the nodes in the exemplary mesh network illustrated in FIG. 1.

FIG. 3 shows a block diagram of an exemplary voice encoder that may be included in the LPH device.

FIG. 4 shows a block diagram of an exemplary voice decoder that may be included in the LPH device.

FIG. 5 shows an exemplary timing diagram of a voice frame from an originating device in a mesh network to a receiving device in the mesh network.

FIG. 6 shows an exemplary embodiment of a network including a mesh network portion and additional components connecting the mesh network portion to further networks.

FIG. 7 shows an exemplary embodiment of the network of FIG. 6 that further includes an exemplary media center.

FIG. 8 shows an exemplary embodiment of the network of FIG. 6 that further includes an exemplary broadcast center.

### DETAILED DESCRIPTION

The exemplary embodiments may be further understood with reference to the following description and the related appended drawings, wherein like elements are provided with the same reference numerals. The present invention is related to devices, systems and methods for initiating and using an ad hoc wireless network to communicate voice and data information. Specifically, the exemplary embodiments implement a plurality of low power handheld devices and relays to create a mesh communications network. The low power handheld devices may communicate among themselves and may also communicate with outside networks as will be described in greater detail below. It is noted that in the following description, the terms “packet” and “frame” are used interchangeably to mean a unit of information that may be communicated between various devices within a network.

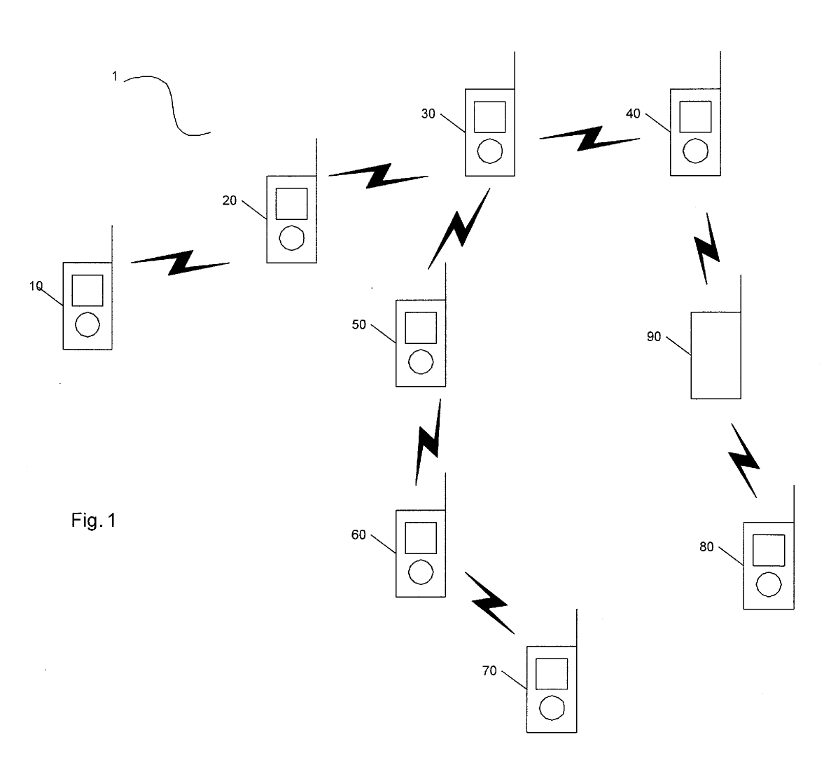

FIG. 1 shows an exemplary mesh network 1 including a plurality of nodes 10-90. Those of skill in the art will understand that a mesh network is a network where each node in the network may act as an independent router. It allows for continuous connections and reconfiguration around broken or blocked paths by “hopping” from node to node until the destination is reached. It is noted that the wireless connections shown between the nodes 10-90 are only exemplary and that other wireless connections may exist. For example, while FIG. 1 shows a wireless connection between nodes 10 and 20, it may also be possible that a wireless connection exists between nodes 10 and 50. Thus, if the wireless connection between node 10 and node 20 was interrupted (e.g., node 20 was shut off, node 20 moved to a different location, node 20 failed, etc), node 10 could continue to communicate with the remainder of the mesh network 1 via node 50.

As will be described in greater detail below, one exemplary protocol that may be used to establish the wireless connection between the various nodes 10-90 may be the ZigBee protocol that is based on the IEEE 802.15.4 standard. The ZigBee protocol may be advantageous in the exemplary embodiments because it is energy efficient thus supporting low power operation. It also supports a large number of hops per connection and a large number of nodes in the mesh network 1. In the exemplary embodiments, this protocol allows for communications between nodes that are spaced approximately 2,000 meters apart from each other. Also in the exemplary embodiments, communications within the mesh network 1 may travel up to 32 hops with minimal impact on the communications. The protocol that is employed is capable of handling approximately 65,000 nodes. Thus, it can be seen that the mesh network 1 can cover a vast area and number of nodes. However, it should be noted that the exemplary embodiments are not limited to the ZigBee protocol. Other protocols may be selected by the network designer, considering distance and power requirements, which may also provide alternate distance per hop, number of hops, and number of nodes in the network.

The mesh network 1 is also referred to as an ad hoc network because membership in the mesh network 1 is not permanent and new nodes may be added or deleted as needed. For example, at time (t0) the mesh network 1 may have been formed and consisted of only nodes 20, 30 and 40. At a further time (t1), node 10 and node 90 may have been added to the mesh network 1. Similarly, at further times the remainder of the nodes may have been added to the mesh network 1. It is also possible that nodes drop out of the network over time. As described in the example above, node 20 may have dropped out of the mesh network 1 for any one of a variety of reasons. However, mesh network 1 remains in existence because other nodes are still capable of communicating. Node 20 may rejoin the mesh network 1 at any time.

Those skilled in the art will understand that mesh networks as they currently exist are generally limited to stationary devices that have access to a permanent power supply. This is due to the fact that these devices must be active at all times in order to support the mesh network. If the network also includes mobile devices, the number of these devices is generally limited because, again, the power requirements results in these devices being quickly drained of power. Moreover, voice communications over mesh networks is very difficult because latency and packet loss result in poor voice quality. However, the exemplary embodiments overcome these and other difficulties associated with current mesh networks.

Continuing with the exemplary mesh network 1 as configured in FIG. 1, if node 10 desires to communicate with node 80 the signal will need to be routed along five (5) hops (e.g., from node 10 to node 20, then to node 30, then to node 40, then to node 90 and finally to its destination of node 80). Thus, it can be seen that when communicating information from node 10 to node 80, multiple nodes are involved in the route. When this communication is voice information, the communication must be almost instantaneous for the two users in the connection to have a meaningful conversation.

In the exemplary embodiment, the nodes 10-90 of the mesh network 1 are the low power devices described above. These devices may be users' portable handheld devices or they may be portable, mobile and/or stationary relay devices placed in strategic geographical locations in order to support the mesh network in areas where direct connections between nodes may not be possible. In the exemplary mesh network 1 as configured in FIG. 1, the nodes 10-80 are considered to be handheld devices and node 90 is considered to be a portable relay device. Since the nodes 10-90 are portable devices they may move freely throughout a physical space in which the mesh network 1 resides. The physical space may be a defined physical space such as a warehouse, a factory, a parking lot, etc. or may be an undefined space such as a theatre of war, a city, etc. To provide a specific example, the node 70 may initially be in a physical location that is in proximity to the nodes 60 and 80 as shown in FIG. 1. However, because the user of node 70 may move within the physical space, the node 70 may move to a different physical location such as in proximity to nodes 30 and 40. As described above, node 70 may then establish a wireless connection with one or both of nodes 30 and 40 rather than the current wireless connection shown on FIG. 1 with node 60 because node 70 may no longer be in a close enough physical proximity to node 60 to maintain the current wireless connection.

Thus, the mesh network 1 allows for wireless communications between the nodes 10-90 without the need for any infrastructure, e.g., cell towers, etc. Every node 10-90 in the mesh network 1, whether it is a handheld device or a relay device, acts as a stand-alone receiver, transmitter and router. In addition, as will be described in greater detail below, because the exemplary embodiments allow for multiple hops when communicating information, the mesh network 1 may be spread out over large distances. Moreover, because each individual device acts as a node of mesh network 1, maintenance is limited to the individual devices. If one of the devices needs to be taken out of service for maintenance purposes, the mesh network 1 will automatically reconfigure to operate without the device that was taken out of service. There is no need for expensive maintenance for network infrastructure devices.

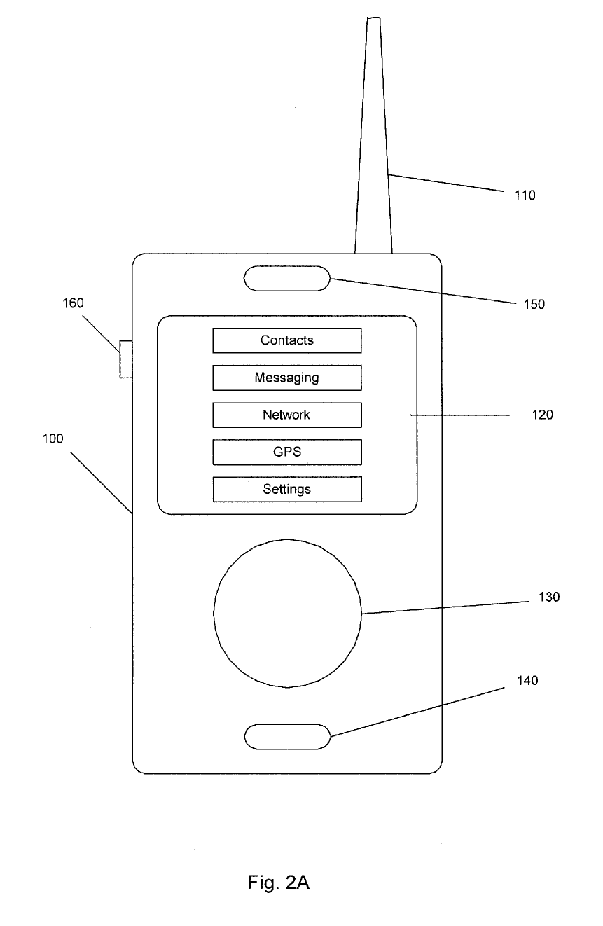

FIG. 2a shows an exemplary low power handheld (LPH) device 100 that may be one of the nodes 10-80 in the mesh network 1. It should be noted that the LPH device 100 is only one exemplary embodiment of a LPH device and that there may be many other types of device configurations that may be implemented as an LPH device. The LPH device 100 includes an antenna arrangement 110, a user display 120, a user interface 130, a microphone 140, a speaker 150, and a Push-To-Talk switch 160. The exemplary LPH device 100 may also include various other components that are not shown in this figure such as a processor, microcontroller, battery, transmitter, receiver, memory, GPS receiver and antenna, etc. The user display 120 may be a 128×128 pixel color LCD screen. The user display 120 may display a list of functionalities performed by the LPH device 100. For example, the user display 120 may display functionalities such as contacts, messaging, network, global positioning (GPS) and settings. In addition, the user display 120 may display a full on-screen QWERTY keyboard and numeric keypad. The user may navigate and select these various functionalities using the user interface 130.

As described above, the exemplary embodiment of the LPH device 100 communicates wirelessly via the ZigBee protocol that is based on the IEEE 802.15.4 standard, at the frequency band referred to as 2.4 GHz. For the LPH device 100 the low power consumption by its components allows for two rechargeable and/or replaceable Li-Ion batteries, each with the capacity of 1750 mAhr, to power the LPH device 100 for 38 hours based on a usage of 5/5/90 (% talk/% receive/% standby) or 31 hours for usage of 10/10/80. As described above, the wireless range of the exemplary LPH device 100 is approximately 2,000 meters assuming a transmit power of 50 mw.

In addition to the wireless communications capabilities, the LPH device 100 may include a USB or other type of port that may be used to program and/or upgrade the software of the LPH device 100 from an external device. This port may also be used to transmit data from an external device (e.g., an unattended ground sensor, etc.) to the mesh network 1. In addition, the LPH device 100 in the exemplary embodiment may be recharged via the USB port. Those skilled in the art will understand that the above specifications for the LPH device 100 are only exemplary. Designers of other handheld devices may desire different functionality and may therefore select different components and/or specifications to suit their needs. For example, a designer may be concerned with battery life, but also know that each of the devices will remain in close proximity to other devices within the network. Thus, this designer may decrease the transmit power in order to extend battery life because the designer is not concerned about transmitting over such a long distance. Conversely, another designer may be willing to sacrifice some battery life by boosting the transmitter's RF power because they know that the devices will be spaced apart at greater distances. In another example, a designer may not desire that the LPH device 100 have GPS capability, thus those components may be eliminated, saving power and space within the LPH device 100. As can be seen from the examples, a designer may make tradeoffs between performance and technical characteristics when implementing an LPH device 100.

FIG. 2b shows an exemplary relay device 800 that may be node 90 in the mesh network 1. It should be noted that the relay device 800 is only one exemplary embodiment of a relay device and that there may be many other types of device configurations that may be implemented as a relay device. The exemplary relay device 800 includes an antenna arrangement 810 and it may also include various other components that are not shown in this figure such as a processor, microcontroller, battery, transmitter, receiver, memory, GPS receiver and antenna, etc. The exemplary embodiment of the relay device 800 communicates wirelessly via ZigBee protocol that is based on the IEEE 802.15.4 standard, at the frequency band referred to as 2.4 GHz.

The relay device 800 may be a stationary, a portable and/or a mobile device. For example, if the mesh network 1 is deployed within a bounded physical space such as a factory, the relay device 800 may be a stationary device permanently mounted to a fixed location such as the ceiling or a column. Such a relay device may then be plugged into a permanent power source such as the AC power for the factory. In another example, if the mesh network 1 is deployed in an unbounded area such as a battlefield, the relay device 800 may be a mobile device located in one or more mobile vehicles such as armored personnel carriers. As these vehicles move, the relay device 800 also moves. In such a situation, the relay device 800 may be powered from the power source of the vehicle (e.g., the vehicle battery) or may have an independent power source. In a further example of the unbounded space, users may position the relay device 800 in locations as needed. For example, in the case of a police or fire emergency, portable relay devices may be brought to the location of the emergency and left in strategic locations to facilitate communications. When the emergency is over, the portable relay devices may then be retrieved for further use at the next emergency. In the case of portable relay devices, it is most likely that a power supply will not be available, thus, the portable relay device may include a self-contained power supply such as a battery or super capacitor. Stationary, portable and/or mobile relay devices may include the mesh networking algorithms so that they can associate with various nodes 10-80. In one exemplary embodiment, the relay device 800 transmitter's RF power may be greater than that of the LPH device 100 so that they may have greater transmission range.

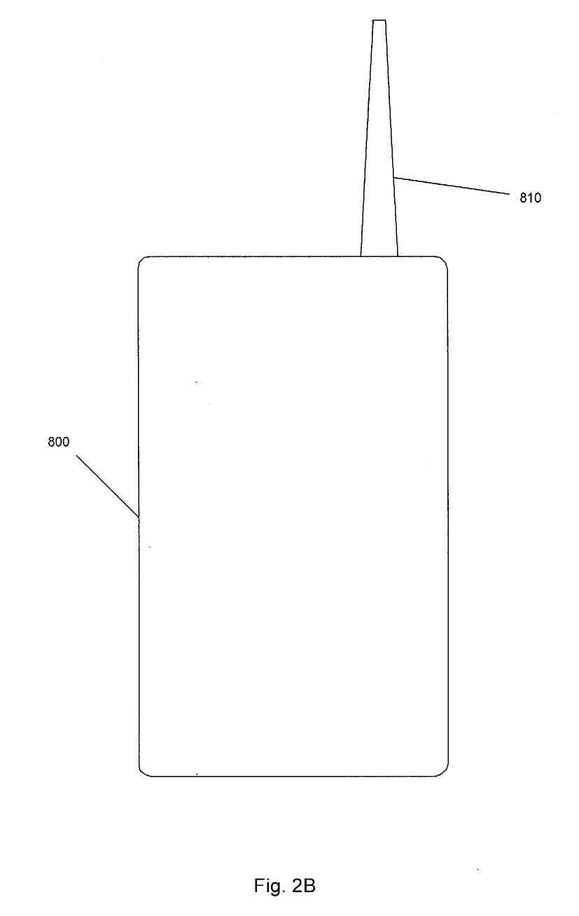

FIG. 3 shows an exemplary block diagram of a voice encoder 200 that may be included in the LPH device 100. In this example it is considered that the user has selected a voice communication functionality using the user interface 130 and the user display 120. Following through with the example stated above it will be considered that the user of node 10 has selected to place a voice call to the node 80. This selection may be made, for example, by selecting the node 80 from the contact list or node list displayed on the user display 120. As described above, such a voice communication in the arrangement of the mesh network 1 shown in FIG. 1 will require five (5) hops in the route. Those skilled in the art will understand that there may be some preliminary communications between the nodes in the route between node 10 and node 80 which are used in the process of call initiation and route mapping. However, these preliminary communications may be any type of known communications in order to set up a call between two nodes on the network. The following description is directed at the voice communications between the two nodes once the call has been initiated.

The voice encoder 200 may be considered to be part of the LPH device 100 that initiated the call. The voice encoder 200 conditions the signal representing the user's voice to be sent to the other nodes. Initially, the user speaks into the microphone 140 and this analog signal is sent to an analog-to-digital converter (ADC) 210. The ADC 210 samples the signal using a linear Pulse Code Modulation (PCM) technique at the sampling rate of 8 KHz which produces a 16 bit sample every 125 microseconds representing the amplitude of the analog signal. The resulting digital signal is a 128 Kbps serial bit stream.

This signal is then sent to an encoding function 220 that processes the signal and produces 20 msec frames that represent 160 samples for a total of 2560 bits (e.g., 320 8-bit bytes). The encoding function 220 further compresses each frame using the GSM (Groupe Special Mobile) full rate compression algorithm to reduce the number of bits to 264 bits (e.g., 33 8-bit bytes). The 20 msec frames are then stored in a frame buffer 230. The signal then travels from the frame buffer 230 to a combiner 240 where the frames are combined. In one exemplary embodiment, the transmission is via the ZigBee protocol and in that protocol the transmission of voice frames requires 40 msec blocks due to the size requirement of the data payload in frames. Thus, the combiner 240 combines two (2) 20 msec frames into a single 40 msec super-frame by retrieving two (2) 20 msec frames from the frame buffer 230 and concatenating them into a single super-frame. The 40 msec super-frames are then sent to a ZigBee module where they are incorporated as data payload into a larger ZigBee frame that contains additional information e.g., addressing information, to complete the connection to the far end receiver.

Those skilled in the art will understand that each of the components of voice encoder 200 described above (e.g., the ADC 210, encoding function 220, frame buffer 230 and combiner 240) may be separate components or their functionality may be combined into one or more components. For example, a microcontroller or a microprocessor may perform the functions of the ADC 210, the encoding function 220, frame buffer 230 and combiner 240. In addition, these functions may be performed by hardware device, software or a combination of both. Furthermore, it should be noted that the above example of the voice encoder 200 coding the signal for transmission is only exemplary and that other types of coding may also be used.

Once the ZigBee frame that includes the voice payload is prepared, the LPH device 100 will transmit it via the antenna 110 to another node on the mesh network 1. In the example, the final destination of the frame is node 80. However, as described above, the node 10 and the node 80 do not have a direct wireless connection. Thus, the frame needs to be sent to node 80 via other nodes (e.g., nodes 20, 30, 40 and 90). It should be noted that the voice communication is meant to be a private communication between the users of nodes 10 and 80. Therefore, while the other nodes will route the frame along the path to its final destination, the users of these intermediate nodes will not have access to the voice payload contained therein. That is, these nodes are merely forwarding the frame along its path to the destination without any processing beyond that which is needed for such forwarding (e.g., without decoding of the voice information). It should also be noted that the communications may be encrypted using, for example, AES-128 encryption with multiple random keys to further enhance information assurance.

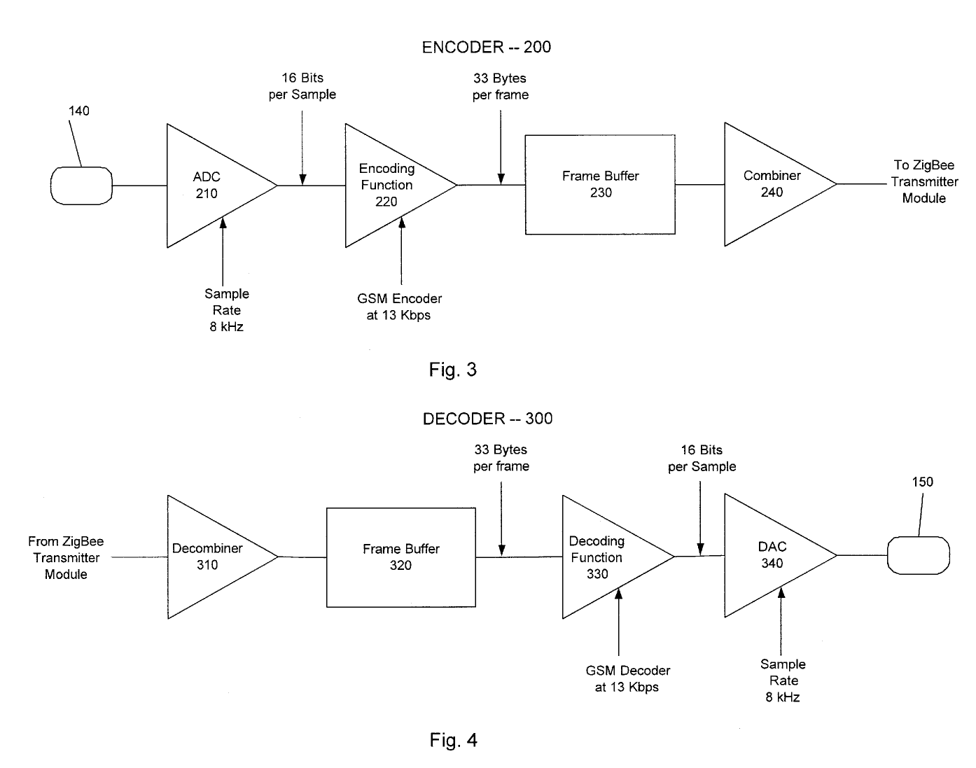

FIG. 4 shows an exemplary voice decoder 300 that may be included in the LPH device 100. In this example, it may be considered that the voice decoder 300 is included in node 80 that is receiving the voice information initiated by the node 10 using the voice encoder 200 described above. However, each of the nodes 10-80 may be equipped with a voice encoder 200 and voice decoder 300. Again, since in this exemplary embodiment, the frames are received using the ZigBee protocol, the node 80 will have a ZigBee receiver module that will receive the 40 msec super-frame that includes the voice information and perform the necessary processing associated with the ZigBee protocol to retrieve the voice payload. This processing may include, for example, stripping away routing and header information that is used to direct the frame to the proper destination, decrypting the frame information, determining the sequence number and time of arrival stamp on the frame to buffer the incoming frames in the proper order, informing the GSM decoder if there is a missing frame as determined by sequence number, and instructing the decoder to do packet-loss concealment for the missing frame.

After this processing is complete, the received super-frame is sent to a decombiner 310 to separate the 40 msec super-frame into the two (2) original 20 msec compressed frames. The 20 msec compressed frames are then stored in a frame buffer 320. A decoding function 330 then retrieves the frames from the frame buffer 320 and reverses the original GSM coding process of the voice encoder 200. Specifically, the received 33 byte frames are retrieved from the frame buffer 320 and de-compressed into the original 320 byte frames. The de-compressed signal is then sent to a voice digital-to-analog converter (DAC) 340 to convert the de-compressed digital signal to an analog signal. The speaker 150 of the node 80 then plays the analog signal.

Those skilled in the art will understand that, similar to the voice encoder 200, each of the components of voice decoder 300 described above may be separate components or their functionality may be combined into one or more components. For example, a microcontroller or a microprocessor may perform the functions of the decombiner 310, frame buffer 320, decoding function 330, and DAC 340. In addition, these functions may be performed by hardware device, software or a combination of both. Furthermore, it should be noted that the above example of the voice decoder 300 decoding the received signal is only exemplary and that other types of decoding may also be used.

The above example showed a voice communication being initiated at a first node (e.g., node 10) and then being received at a destination node (e.g., node 80). However, as described above, in this example there are four (4) intermediate hops between the initiating node 10 and the receiving node 80 (e.g., nodes 20, 30, 40 and 90). In addition, the intermediate nodes do not retrieve the voice information. That is, the communication between node 10 and node 80 may be considered a unicast transmission, e.g., a communication from one node destined for one other node also referred to as peer-to-peer communications. This is opposed to a multicast or broadcast transmission, e.g., a communication from one node destined for multiple other nodes which nodes 10-80 may also be able to perform.

Normally, in unicast voice transmissions, each node hop requires the sending of a frame from a first node to a second node. The second node, upon receipt of the frame, sends an acknowledgement back to the first node indicating that it received the first frame. If the first node does not receive the acknowledgement within a predetermined period of time, the first node resends the first frame to the second node and then waits for an acknowledgement of the resend. If the second node successfully receives the first frame and sends the acknowledgment back to the first node, the second node will forward the first frame to the third node along its path to the destination. The communication between the second node and the third node concerning the first frame will operate in the same manner as the communication between the first node and the second node. This pattern will continue until the first frame reaches its final destination.

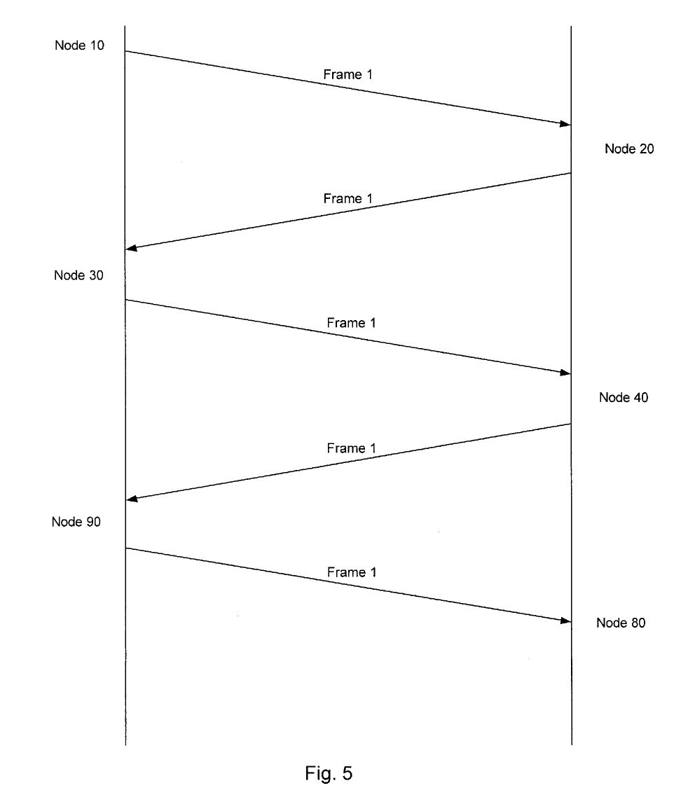

In the exemplary embodiments, the unicast voice transmission is performed without acknowledgements being sent back to the sending node. FIG. 5 shows an exemplary timing diagram of a voice frame from an originating node 10 to a receiving node 80. As shown in this timing diagram, node 10 sends the voice frame to node 20. The node 20 receives the voice frame, determines that the voice frame is not intended for node 20 and then determines which next node the voice frame should be forwarded to. The node 20 then forwards the voice frame to node 30 (e.g., the next node to which the voice frame should be forwarded). It is noted that node 20 does not send an acknowledgement back to node 10 indicating that node 20 received the voice frame. Similarly, node 30 performs the same processing as node 20 and forwards the voice frame to node 40, which then forwards the voice frame to node 90, which then forwards the voice frame to the destination node 80. When the voice frame reaches node 80, the node 80 determines that the voice frame is intended for the node 80 and processes the voice frame accordingly, e.g., the voice frame is processed as described above with reference to the voice decoder 300 to output the voice signal to the user. As shown in FIG. 5, there are no acknowledgements along any of the hops that the voice frame takes from its initiating node 10 to its destination node 80.

As noted above, the lack of acknowledgements for a unicast voice transmission is not the normal mode of operation for the ZigBee protocol but is done in the exemplary embodiments to reduce latency and packet loss. The exemplary embodiments may still include acknowledgements for data frames, system level frames and call set-up frames, e.g. call invitations and mesh routing table updates. Thus, the exemplary embodiments change a header byte of the voice frame to indicate that an acknowledgement is not used for the voice transmission. Similarly, the LPH device 100 firmware is configured such that when receiving such a transmission, an acknowledgement is not sent. As described above, other protocols may also be used to send the voice transmissions. Similar changes to the frame and/or firmware may be made based on the particular protocol to accomplish the non-acknowledged unicast voice transmissions.

In the above description it was stated that nodes freely join or drop out of the mesh network 1. When a node joins the mesh network 1, various actions occur such as the node being assigned a dynamic network address and a network identification. Similarly, various actions also occur when a node is disassociated from the network. For security reasons, the nodes 10-90 may include a functionality to receive a message from a remote node, determined based on network management procedures, to turn themselves off or even to self-destruct (such as by wiping firmware) so that they are no longer usable. In addition, it was also stated that nodes within the network forward packets to other nodes within the mesh network 1 on their way to the final destination. It is noted that these actions are not necessarily trivial undertakings. However, there are well-known mesh networking algorithms for accomplishing these tasks and the exemplary embodiments may use any of the known types of mesh networking algorithms.

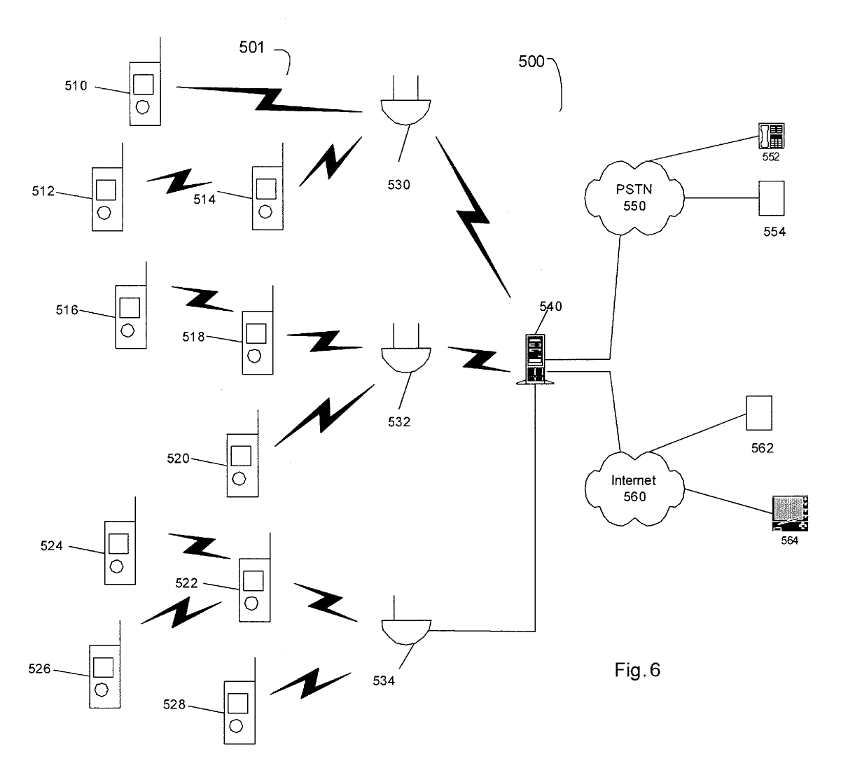

FIG. 6 shows an exemplary embodiment of a network 500 which includes a mesh network portion 501 and additional components used in connecting the mesh network portion 501 to further networks. Initially, the mesh network portion 501 includes a plurality of portable handheld devices 510-528 (similar to the LPH device 100 and relay device 800). The mesh network portion 501 may operate in a substantially similar way to the mesh network 1 and its various components described above. For example, various portable devices may join or drop out of the mesh network portion 501, devices may forward packets among the various devices, etc. In this example, the devices 510-528 communicate amongst themselves using the ZigBee protocol.

The network 500 also includes zip modules 530-534 that are devices providing an interface between the mesh network portion 501 and further elements of the network 500 such as the gateway 540. In the exemplary embodiment, zip modules 530 and 532 are shown as multi-antenna modules, while zip module 534 is shown as a single antenna module. The zip modules 530-532 have multiple antennas because they communicate with the mesh network portion 501 devices and the gateway 540 wirelessly. For example, in this exemplary embodiment the device 510 communicates with the zip module 530 using the ZigBee protocol. The zip module 530 further communicates with the gateway 540 using another wireless protocol (e.g., the IEEE 802.11b/g Wi-Fi protocol). Thus, the zip module 530 uses two different antennas to communicate with the different protocols. On the other hand, the zip module 534 communicates with the devices 510-528 using the ZigBee protocol on the single antenna. Communication between the zip module 534 and the gateway 540 is accomplished via a serial and/or USB hardwired connection. Thus, zip module 534 only needs the single antenna. Those skilled in the art will understand that the zip modules may be equipped with any number of antennas and data ports to communicate with any types of protocols that they are configured to support.

In the exemplary embodiments, the zip modules 530-532 transform the ZigBee packets received from the devices 510-528 into IP packets. The zip modules 530-532 maintain a TCP/IP connection with the gateway 540 and when the ZigBee packets are received, the zip modules 530-532 place the ZigBee packet into an IP packet. That is, the received ZigBee packet is wrapped in an IP packet and then it is forwarded to the gateway 540 for further processing. This further processing will be described in greater detail below. The received ZigBee packet may also be sent for further processing without being wrapped in IP, for example, when there is a serial and/or USB connection between the zip module 534 and the gateway 540.

The zip modules 530-534 may be a portable, mobile and/or a stationary device. For example, if the mesh network portion 501 is deployed within a bounded physical space such as a factory, the zip modules 530-534 may be permanently mounted to a fixed location such as the ceiling or a column. The zip module may then be plugged into a permanent power source such as the AC power for the factory. In another example, if the mesh network 501 is deployed in an unbounded area such as a battlefield, the zip modules 530-534 may be located in one or more mobile vehicles such as armored personnel carriers. As these vehicles move, the zip modules 530-534 also move. In such a situation, the zip modules 530-534 may be powered from the power source of the vehicle (e.g., the vehicle battery) or may have an independent power source. In a further example of the unbounded space, users may position the zip modules 530-534 in other locations as needed. For example, in the case of a police or fire emergency, portable zip modules may be brought to the location of the emergency and left in strategic locations to facilitate communications. When the emergency is over, the portable zip modules may then be retrieved for further use at the next emergency. In the case of portable zip modules, it is most likely that a power supply will not be available, thus, the portable zip module may include a self-contained power supply such as a battery or super capacitor. Stationary, portable and/or mobile zip modules may include the mesh networking algorithms so that they can associate with various devices 510-528. In one exemplary embodiment, the zip module 530-534 transmitter power is greater than that of the devices 510-528 so that they may have greater transmission range. In addition, for security reasons, the zip modules 530-534 may include a functionality to receive a message from a remote device, determined based on network management procedures, to turn itself off or even to self destruct (such as by wiping firmware) so that they are no longer usable. This may be useful in the battlefield scenario described above.

The hardware included within the zip modules 530-534 may include a microcontroller (or other computing arrangement), receiver and transmitter to perform the above described functions. In the exemplary embodiments, the zip modules do not consume a large amount of power and are made to be as physically small as possible so that they do not take up a large amount of space and that it may be concealed in some applications. In one exemplary embodiment, a zip module is powered by a 5V, 500 mA-1 A power supply.

The gateway 540 may be implemented as a stand-alone network device or it may be implemented as part of another computing device such as a server that is servicing the network 500. The gateway 540 receives the packets from the zip modules 530-534 (e.g., in one exemplary embodiment the ZigBee packets are wrapped in the IP packet) and converts them into the necessary format to be communicated with other networks. An example of this interface with other networks will be described in greater detail below.

The above provided a description of the sending of packets from the mesh network portion 501 to the gateway 540. Packets will also need to be sent in the opposite direction (e.g., from the gateway 540 to the mesh network portion 501). When the gateway 540 receives data from one of the further networks (e.g., the public switched telephone network (PSTN) 550 or the Internet 560), the gateway 540 converts the data into a ZigBee packet and may then wrap the ZigBee packet in an IP packet (e.g., if the connection between the gateway 540 and the zip modules 530-534 is IP-based). Those of skill in the art will understand that there are known methods for converting a ZigBee packet to another format and vice versa. The gateway 540 will include any of known functionalities to make the conversion. In addition, the zip modules 530-534 and the gateway 540 may also include the functionality of ZigBee to other data format transformation. However, because this adds processing overhead to the zip module, it means that the zip module will need more processing resources and also use more power. Thus, in an effort to keep the zip modules more streamlined and using less power, the packet conversion is preferred to be performed in the gateway 540. However, it is not a requirement that the packet conversion is performed in the gateway 540.

After the gateway 540 converts the packet to the ZigBee format and may wrap the ZigBee packet in an IP packet (e.g., if the connection between the gateway 540 and the zip modules 530-534 is IP-based), the gateway 540 transmits the packet to one of the zip modules 530-534. If the ZigBee packet is wrapped in an IP packet, the zip modules 530-534 deconstruct the IP packet to obtain the encapsulated ZigBee packet. The zip modules 530-534 then forward the ZigBee packet to the mesh network portion 501 where the ZigBee packet is forwarded to the destination devices 510-528. As also described above, if the connection between the gateway 540 and the zip modules 530-534 is not IP-based (e.g., where the gateway 540 is transmitting the ZigBee packet to the zip module 534 via the USB and/or Serial connection), the ZigBee packet may not be wrapped in the IP packet for such a transmission.

The following provides an example of a user of the mesh network portion 501 making a phone call to a user of another network 550 or 560. Specifically, the user of the device 512 is attempting to make a call to the cell phone 554. However, the same procedure would be used if the user is attempting to call the landline phone 552. As described above, the device 512 may be the LPH device 100. Thus, to make a phone call to a further network device, the user of device 512 may select a person from the contact list that includes a standard telephone number (e.g., XXX-YYY-ZZZZ). The LPH device 512 may also include the functionality to display a numeric keypad on the user display 120 and then use the user interface 130 to key in a standard telephone number.

The LPH device 512 information which indicates that this is a further network call is in a ZigBee packet originating in LPH device 512 and forwarded via device 514 to the zip module 530. Since the zip modules 530-534 are part of the mesh network portion 501, the devices 510-528 will maintain information regarding which of the zip modules 530-534 is in closest proximity to it so that it can be used to make a further network connection. That is, because each device 510-528 may act as a router, it will maintain information regarding the shortest distance to other network devices, including the zip modules 530-534. The identification of the closest zip module 530-534 should result in the fewest number of hops and therefore, the least amount of latency in the communications between the device initiating the call and the final destination of the call. The zip module used during a call may change based on movement of the devices 510-528 in the network or the zip modules 530-534. In one exemplary embodiment, a zip module is selected for a particular voice segment of the call and the entirety of that voice segment will be processed through the same zip module. A voice segment may include the total voice being generated from the time the Push-To-Talk (PTT) switch is activated to the time it is released. This identification of the closest zip module 530-534 may be performed each time the device 510-528 is establishing or routing a voice segment. In one exemplary embodiment, the searching for the closest zip module 530-534 may be performed at the application layer level within the devices 510-528. However, it may also be possible to implement this searching capability at lower level layers. Thus, in this example, the device 510 has identified the zip module 530 as the closest zip module.

As described above, the zip module 530 may convert the ZigBee packet into an IP packet by encapsulating the ZigBee packet and forwarding the IP packet to the gateway 540. It should be noted that each zip module 530-534 may simultaneously receive and process multiple voice and data communications from different devices within the mesh network portion 501 and forward the communications to the gateway 540. Similarly, a zip module may also forward multiple voice and data communications in the other direction, e.g. from the gateway 540 to the devices 510-528.

The gateway 540 may include a software application that is used for call handling to interface with the PSTN 550. For example, the software application may support mapping of the ZigBee medium access (MAC) layer address of each device 510-528 to a phone number, based on network management procedures. In that case, the gateway 540 may store a table of authorized devices 510-528 and their corresponding phone numbers. A single phone number may be assigned to each of the devices 510-528 or the gateway may operate in a manner consistent with a Private Branch Exchange (PBX) which assigns each device 510-528 an extension as needed. Examples of software applications that may be executed by the gateway 540 to provide various phone and messaging functionality may be the OpenSIPS software application and the Asterisk software application. However, the exemplary embodiments are not limited to these software applications. Any software applications that accomplish the functionality described herein will suffice. Thus, when the gateway 540 receives the ZigBee packet from LPH device 512, including the request to set up the phone call with the cell phone 554, when the gateway forwards the request to the PSTN 550, it will include the phone number assigned to the device 512. The gateway 540 will convert the request to set up the call with the cell phone 554 into a format that is compatible with the PSTN 550 and send the request to the PSTN 550. If the call is successfully completed, the PSTN 550 will send information back to the gateway 540 and the gateway 540 may then manage the information exchange between the network 500 and the PSTN 550. For example, as the gateway 540 receives ZigBee packets including the audio payload initiated by the device 512, the gateway 540 may convert these packets into the format required by the PSTN 550 and forward the audio payload to the PSTN 550.

Similarly, as the gateway 540 receives the audio signal from the PSTN 550 that was generated by the cell phone 554, the gateway 540 converts this audio information into the ZigBee packet and sends the ZigBee packet encapsulated in an IP packet to the zip module 530. The gateway 540 may perform a search for the zip module 530-534 that is closest to the destination device for the information that the gateway 540 is attempting to send to the destination device. The zip module used during a call may change based on movement of the devices 510-528 in the network or the zip modules 530-534. In one exemplary embodiment, a zip module is selected for a particular voice segment of the call and the entirety of that voice segment will be processed through the same zip module. This identification of the closest zip module 530-534 may be performed each time the gateway 540 is routing a voice segment. The gateway 540 may also maintain a database of mesh network devices and their corresponding closest zip module which the gateway 540 may periodically update. This allows the gateway 540 to send out packets with the highest probability of a successful connection. Thus, in this example, the gateway 540 has determined that zip module 530 remains the closest zip module to the device 512. The zip module 530 deconstructs the IP packet and forwards the ZigBee packet to the device 512 via the device 514.

In another example, the device 512 may desire to place a phone call to a SIP phone 562 connected to the Internet 560. SIP phones generally use addresses that include the IP address of the SIP server (e.g., sip:6713@192.168.26.180:6060). These addresses may be impractical to enter into the device manually. Thus, the device 512 will store a SIP Contact ID corresponding to the SIP phone 562. The full address is mapped to the SIP Contact ID at the gateway 540. Similar to the PSTN 550 example, the device 512 will format the request in ZigBee packets and forward the ZigBee packets via the device 514 to the zip module 530. As described above, the zip module 530 converts the ZigBee packet into an IP packet by encapsulating the ZigBee packet in an IP packet and forwards the IP packet to the gateway 540.

Similar to the PSTN 550 example, the gateway 540 will include software that processes the received ZigBee packet to convert it to the format required by the Internet 560. Specifically, the ZigBee packet will be translated into an IP packet. While the gateway 540 receives the packet as an IP packet, it is of a format that the IP packet includes the encapsulated ZigBee packet. The gateway 540 will transform the packet into a standard IP packet that can be routed through the Internet 560. In addition, the gateway 540 may also perform additional processing of the request. For example, as described above, the request will include the SIP Contact ID. The gateway 540 will include the mapping of the SIP Contact ID to the full address of the SIP phone 562 and the gateway 540 will insert the full address into the request IP packets. In addition, the gateway may be capable of mapping the MAC address of the device 512 to a SIP address that is included in the request packets. The gateway 540 also provides other functionality associated with SIP call processing such as registration.

The gateway 540 will convert the request to set up the call with the SIP phone 562 into the SIP format and send the request to the Internet 560. If the call is successfully completed, information will be forwarded from the Internet 560 back to the gateway 540 and the gateway 540 may then manage the information exchange between the network 500 and the Internet 560. For example, as the gateway 540 receives ZigBee packets including the audio payload initiated by the device 512, the gateway 540 may convert these packets into the format required by the Internet 560 and forward the audio payload to the SIP phone 562 via the Internet 560. Similarly, as the gateway 540 receives the IP packets including the audio signal from the Internet 560 that was generated by the SIP phone 562, the gateway 540 converts this audio information into the ZigBee packets that may be communicated to the device 512.

The above provided examples of voice communications between devices within the network 500 and further networks (e.g., PSTN 550 and Internet 560). However, communications are not limited to voice communications. The exemplary embodiments may also include data communications such as instant messaging (IM). IM service may be based on, for example, the Session Initiation Protocol for Instant Messaging and Presence Leveraging Extension (SIMPLE) or the Extensible Messaging and Presence Protocol (XMPP). The devices 510-528 may also be provided with the option of sending an IM. As described above, the LPH device 100 includes messaging functionality that may be selected using the user interface 130. When this option is selected, the user may then use the QWERTY keyboard displayed on the user display 120 and the user interface 130 to enter the text of the IM. The user may also use the user interface 130 to select the receiver of the IM.

Thus, in this example, it may be considered that the device 526 is sending the IM to the IM client 564. The device 526 will format ZigBee messaging packets addressed to the IM client 564. The device 526 will then forward these packets to the zip module 534 via the device 522. The zip module 534 will forward the packets to the gateway 540 via the serial and/or USB connection. The gateway 540 will then translate the ZigBee messaging into the IM messaging protocol appropriate for the IM client 564 and forward the message to the IM client 564 via the Internet 560.

The gateway 540 may also support other functionalities such as Push-To-Talk (PTT) functionality, voice mail (e.g., storing messages for users of devices that are not available), etc. Specific examples are not provided of these functionalities, but based on the above description, those of skill in the art should understand the principles of implementing these and other functionalities.

As can be seen from the above examples, the devices 510-528 have full communications functionality among themselves and with the outside world such as landline phones, cell phones, SIP phones, etc. Thus, the users of the devices 510-528 would not need to have any other communications devices when they are connected to the network 500. For example, if the network 500 were deployed in a factory setting, the users of the devices 510-528 could communicate with other users of the devices 510-528. In addition, the users could communicate with persons outside the network 500 such as suppliers, trucking companies, government officials, etc., by using the methods described above to connect outside the network 500. Thus, the owner of the factory would not need to supply these users with other communications devices such as cell phones resulting in a great cost saving to the owner. Moreover, because these calls and IMs may be provided via the Internet, there may not be any usage charges associated with these activities. That is, the owner's charge may be limited to the access fees from its ISP with no separate charges for calls or IMs.

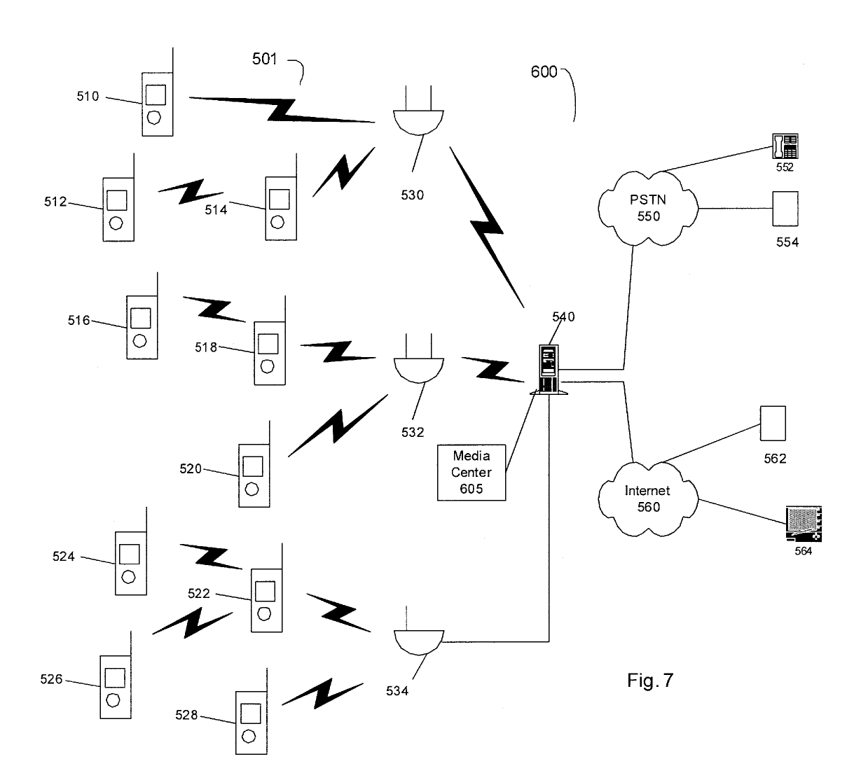

FIG. 7 shows a further example of a network 600 having a mesh network portion 501. The network 600 is identical to the network 500 described with reference to FIG. 6, except that network 600 also includes a media center 605. The remaining components of the network 600 will not be described because they have been previously described above. The media center 605 may be connected to the gateway 540 or may be included in the same server device as the gateway 540. In another exemplary embodiment, it may also be possible to connect the media center 605 to its own zip module or mesh network device for direct communication with the mesh network devices 510-528. In a further exemplary embodiment, the media center 605 may be connected to the gateway 540 via the Internet 560 or the PSTN 550.

Users of the devices 510-528 may desire access to rich media files such as images, maps, audio, video, etc. However, as described above, in an attempt to keep the devices 510-528 as low power as possible, the processing power and memory capabilities of the devices 510-528 may not be sufficient to handle the storage and processing of the rich media files. Additionally storage of rich media files on the devices 510-528 decreases network security by allowing access to large amounts of information on lost or stolen devices. In the exemplary embodiments, this storage and processing of rich media files is offloaded to the media center 605.

To provide a specific example, the user of device 514 may be a soldier in the field who desires to look at a specific map. As described above, device 514 does not have the capabilities of storing a map and performing various processing of the map. Thus, the user of device 514 may send a request to the media center 605 for the map. In one example the request may be routed through zip module 530 to gateway 540 on its path to the media center 605. The media center 605 will retrieve the appropriate map from its memory and send that information to the device 514. The user may then display the map on the user display 120.

The user may then desire to perform some operation on the displayed map such as panning or zooming. Again, the device 514 may not have the capability to process such requests. Thus, the user of device 514 will enter the request for the pan, zoom, etc. via the user interface 130. For example, the user display 120 may display the map with an overlay including processing functions that are selectable by the user. The device 514 will then format the request and send the request to the media center 605 via the zip modules 530 and gateway 540. The media center 605 will then perform the desired processing on the map (e.g., pan, zoom, etc.) and send the re-processed map back to the device 514 for display. As can be seen from this example, a great deal of processing and storage is offloaded from the devices 510-528 to the media center 605. This allows the devices 510-528 to remain relatively lightweight with respect to processing power and memory requirements, thereby saving power at the devices 510-528. Meanwhile, since the media center may reside anywhere, its processing power and memory may not be limited. Those skilled in the art will understand that while the above example used a map to explain the functionality of the media center, similar operations may be applied to other types of rich media.

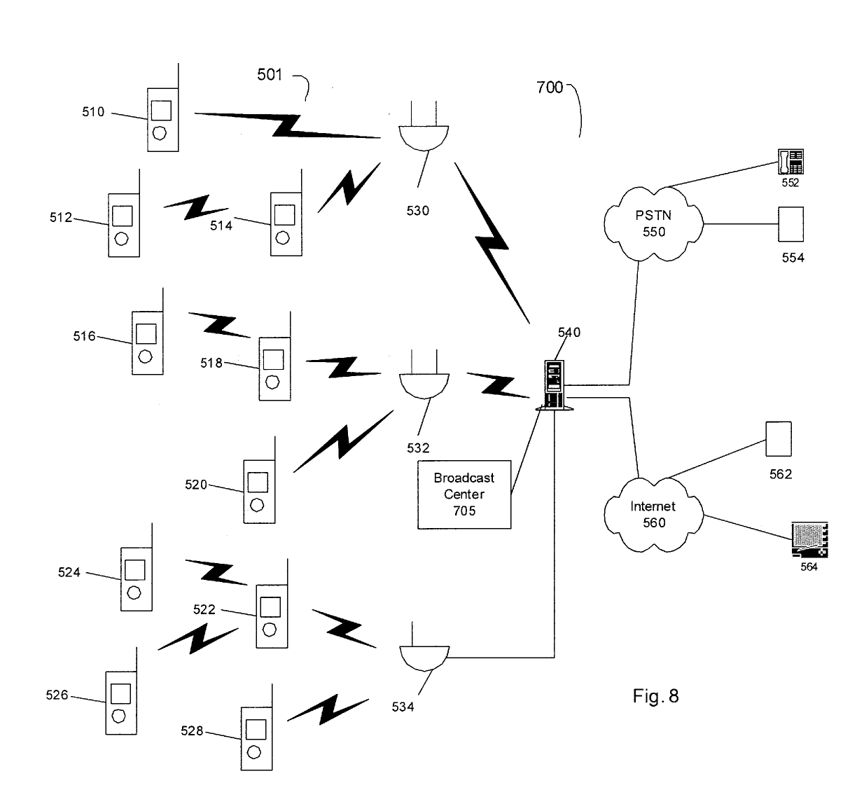

FIG. 8 shows a further example of a network 700 having a mesh network portion 501. The network 700 is identical to the network 500 described with reference to FIG. 6, except that network 700 also includes a broadcast center 705 which functions as described below. The remaining components of the network 700 will not be described because they have been previously described above. The broadcast center 705 may be connected to the gateway 540 or may be included in the same server device as the gateway 540. In another exemplary embodiment, it may also be possible to connect the broadcast center 705 to its own zip module or mesh network device for direct communication with the mesh network devices 510-528. In a further exemplary embodiment, the broadcast center 705 may be connected to the gateway 540 via the Internet 560 or the PSTN 550.

Users of the devices 510-528 may desire to broadcast voice and data communications to a group of users or to all users in the network 501. As described above, a broadcast is a one-to-many communications method and while devices 510-528 may have the ability to broadcast voice and data communications it is possible that such broadcast communications will “flood” the network and cause it to function improperly. This is due to the possibility that devices in a mesh network could receive the same packet one or more times from one or more devices. In addition, network management procedures may dictate that certain devices 510-528 not be given the ability to broadcast and that others may have priority in broadcast communications (e.g. device 524 is ranked higher than device 516). In the exemplary embodiments, broadcast voice is offloaded to the broadcast center 705 while broadcast data is performed directly by the network devices 510-528. However, it is possible to have all broadcast communications offloaded to the broadcast center 705 and/or have all broadcast communications performed by the network devices 510-528.

To provide a specific example, the user of device 514 may be a soldier in the field who desires to broadcast voice to all users in the network 501. The user of device 514 may then send a broadcast request to the broadcast center 705. The request may be routed through zip module 530 to gateway 540 on its path to the broadcast center 705. The broadcast center 705 will check to see if device 514 has permission to broadcast voice and whether a higher ranking device has also sent a broadcast request. The broadcast center will then send the voice broadcast generated by the device 514 to each device in the network 501. In this way each device will only receive the message once. In another example, the device 514 may want to send a voice broadcast to a predetermined group of devices (e.g. device 510, device 522, and cell phone 554). The broadcast center 705 may maintain this list of group members and add devices to it according to network management procedures. As can be seen from this example, a great deal of processing and storage is offloaded from the devices 510-528 to the broadcast center 705.

It should be noted that the functionality described herein may be implemented in hardware devices using a combination of hardware components and software components. For example, a device may include a processor that executes a set of instructions that are stored in a computer readable storage medium (such as a memory) to provide the described functionality. In another example, a controller may execute firmware instructions stored in a component of a printed circuit board (PCB). Thus, the term processor or processing component is not limited to a traditional processor, but may include any device that is capable of executing instructions. Furthermore, a processing component may also include multiple hardware components such as a series of hardware components that are arranged on a PCB to accomplish the described functionality (e.g., not all of the hardware components of a processing component are capable of executing instructions). In addition, the term “mobile devices” has been used throughout this description and some exemplary mobile devices have been described such as LPH device 100, relay device 800 and zip module 530. However, the exemplary embodiments are not limited to these types of mobile devices.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A device, comprising:
a receiver receiving an encoded voice communication from a first further device, wherein the receipt of the encoded voice communication is not acknowledged by the device to the first further device;
a processing component determining if the encoded voice communication is destined for the device; and
a transmitter transmitting the encoded voice communication to a second further device, when it is determined that the encoded voice communication is not destined for the device.

2. The device of claim 1, further comprising:
a user display to display information to a user; and.
a user interface to receive information from the user.
an interface to receive information from external devices.

3. The device of claim 1, wherein the device is a relay device that is excluded from processing user input.

4. The device of claim 1, further comprising:
a speaker, wherein, when the processing component determines that the encoded voice communication is destined for the device, the processing component decodes the encoded voice communication and plays the decoded voice communication over the speaker.

5. The device of claim 1, wherein the processing component determines the second further device to transmit the encoded voice communication to based on routing information stored in the device.

6. The device of claim 1, further comprising:
a microphone for receiving an audible signal from a user, wherein the processing component generates a second encoded voice communication based on the audible signal.

7. The device of claim 6, wherein the processing component encrypts the second encoded voice communication.

8. The device of claim 1, wherein the receiver and transmitter operate based on the IEEE 802.15.4 standard.

9. A system, comprising:
a plurality of mobile devices forming a network by each mobile device having a wireless connection to at least one of the other mobile devices, one of the mobile devices receiving an encoded voice communication from a first further one of the mobile devices, determining whether the encoded voice communication is destined for the one of the mobile devices and, when the encoded voice communication is determined to be destined for another one of the mobile devices, transmitting the encoded voice communication to a second further one of the mobile devices without sending an acknowledgement to the first one of the mobile devices.

10. The system of claim 9, wherein, when the one of the mobile devices determines that the encoded voice communication is destined for the one of the mobile devices, the one of the mobile devices decodes the encoded voice communication.

11. The system of claim 9, wherein the one of the mobile devices selects the second further one of the mobile devices for transmitting the encoded voice communication based on routing information stored in the one of the mobile devices.

12. The system of claim 9, wherein the second further one of the mobile devices is the mobile device to which the encoded voice communication is destined.

13. The system of claim 9, wherein at least a portion of the mobile devices are low power handheld devices including a user display and a user interface.

14. The system of claim 9, wherein at least a portion of the mobile devices are relay devices.

15. The system of claim 9, wherein the network is a mesh network, each mobile device including a mesh networking algorithm to form the wireless connection to the at least one other mobile device.

16. The system of claim 9, wherein the wireless connection is based on the IEEE 802.15.4 standard.

17. A system, comprising:
a plurality of mobile devices forming a first portion of a communications network by each mobile device having a first wireless connection with at least one other mobile device, communication via the first wireless connection being based on a first protocol;
a zip module forming a second portion of the communications network by having a second wireless connection with at least one of the mobile devices, communication via the second wireless connection being based on the first protocol; and
a network gateway forming a third portion of the communications network by having a connection with the zip module, communication via the connection being based on a second protocol.

18. The system of claim 17, wherein the connection is a wireless connection or a wired connection.

19. The system of claim 17, wherein the first protocol is the IEEE 802.15.4 standard.

20. The system of claim 17, wherein the second protocol is an internet protocol (IP) based protocol.

21. The system of claim 17, wherein the first protocol and the second protocol are the same protocol.

22. The system of claim 17, wherein the zip module receives a communication from the at least one mobile device in a format of the first protocol and converts it to a second format of the second protocol, the zip module transmitting the communication in the second format to the network gateway.

23. The system of claim 22, wherein the network gateway receives the communication in the second format and converts it to a third format corresponding to a third protocol of a further communications network and transmits the communication in the third format to the further communications network.

24. The system of claim 23, wherein the further communications network is one of a Public Switched Telephone Network (PSTN) and an Internet.

25. The system of claim 23, wherein the communication is one of a voice communication and an instant messaging (IM) communication.

26. The system of claim 17, wherein the network gateway receives a communication from a further communications network destined for one of the mobile devices, reformats the communication into a format of the second protocol and transmits the communication to the zip module, the zip module reformats the communication into a format of the first protocol and transmits the communication to the one of the mobile devices.

27. The system of claim 17, wherein the zip module is a plurality of zip modules and the network gateway receives a communication from a further communications network destined for one of the mobile devices, determines which of the zip modules is in communication with the one of the mobile devices and transmits the communication to the determined zip module.

28. The system of claim 17, further comprising:
a media center storing rich media files, wherein a user of one of the mobile devices sends a request for a rich media file to the media center, the media center sending the rich media file to the one of the mobile devices.

29. The system of claim 28, wherein the media center further includes operational functionality for the rich media files, wherein the user of the one of the mobile devices sends a further request for an operation to be performed on the rich media file, the media center sending the rich media file having the operation performed to the one of the mobile devices.

30. The system of claim 17, further comprising:
a broadcast center receiving a request from one of the mobile devices to broadcast a communication to more than one of the other mobile devices, the broadcast center determining whether the one of the mobile devices has permission to broadcast the communication, and when the one of the mobile devices has permission, sending the communication to the more than one of the other mobile devices.

31. The system of claim 30, wherein the broadcast center further determines whether a higher ranking mobile device has also sent a broadcast request and gives priority to the higher ranking device.
